(19) United States
(12) Patent Application Publication
(10) Pub. No.: US 2003/0228132 A1
(43) Pub. Date: Dec. 11, 2003

(54) Audio-visual content editing peripheral and system

(76) Inventors: Steve Sucher, Redondo Beach, CA (US); Jake Aalfs, Busna Park, CA (US); Craig Stock, Torrance, CA (US)

Correspondence Address: KOLISCH HARTWELL, P.C., 520 S.W. YAMHILL STREET, SUITE 200, PORTLAND, OR, 97204, US

(21) Appl. No.: 10/431,339

(22) Filed: May 6, 2003

Related U.S. Application Data
(60) Provisional application No. 60/378,463, filed on May 6, 2002.

(51) Int. Cl. H04N 5/781; G11B 27/00; H04N 5/76

(52) U.S. Cl. 386/52; 386/125

(57) ABSTRACT

An audio-visual content editing peripheral. The peripheral includes a capture system configured to convert an audio-visual signal into digital audio-visual data, and an interface configured to transfer the digital audio-visual data to a computing system programmed to execute an audio-visual editing application. The peripheral also includes a control console configured to control the audio-visual editing application.

### CROSS-REFERENCE TO RELATED APPLICATIONS

This application claims priority under 35 U.S.C. § 119(e) from the following co-pending provisional patent application, which is incorporated herein by this reference, in its entirety and for all purposes: SYSTEM FOR INPUTTING, MIXING, EDITING AND OUTPUTTING AUDIO-VISUAL CONTENT, Ser. No. 60/378,463, filed May 6, 2002.

### BACKGROUND

Present systems for editing audio-visual content have been expensive, unavailable to general consumers, and complicated to set up and operate. Because video editing was difficult, time consuming, and expensive, most people could not edit video. However, editing video allows the creation of personalized audio-visual content desired by many people. Furthermore, video editing is a creative process that is enjoyable when the proper editing equipment is available.

### SUMMARY

An audio-visual content editing peripheral is provided. The peripheral includes a capture system configured to convert an audio-visual signal into digital audio-visual data, and an interface configured to transfer the digital audio-visual data to a computing system programmed to execute an audio-visual editing application. The peripheral also includes a control console configured to control the audio-visual editing application.

### BRIEF DESCRIPTION OF THE DRAWINGS

FIG. 1 is a schematic representation of an audio-visual editing system including a computing system and an audio-visual peripheral.

FIG. 2 is a top view of an exemplary audio-visual peripheral.

FIG. 3 is a side view of the audio-visual peripheral of FIG. 2.

FIG. 4 is a back view of the audio-visual peripheral of FIG. 2.

### DETAILED DESCRIPTION AND BEST MODE

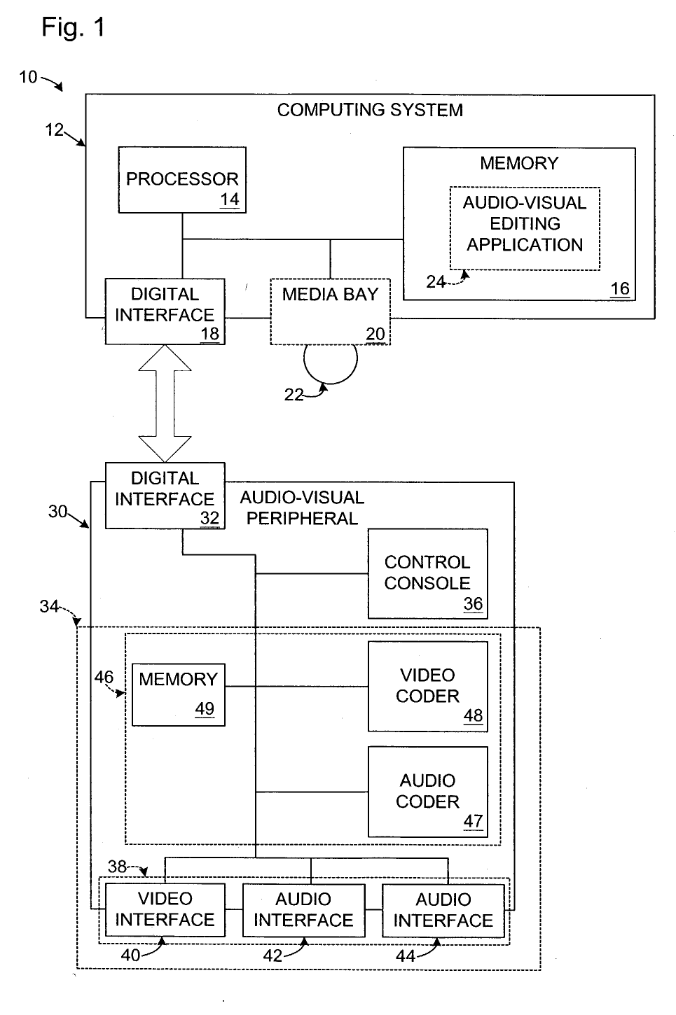

FIG. 1 schematically illustrates an audio-visual editing system 10. As used herein, the term “audio-visual” is used to describe audio content and/or video content. As described below, such content may be represented by one or more interpretable analog signals, the frequency, amplitude, and/or other attributes of which may effectively represent the content in a form that may be conveyed via wired or wireless transmission. The same content may also be represented by coded digital data, which may be compressed or uncompressed, and which represents analog data encoded or sampled at a variety of frequencies and/or bit rates. Such digital data may be read, written, and/or edited by a computing system, such as a personal computer.

Audio-visual editing system 10 includes a computing system 12, which has been schematically illustrated in simplified form. Computing system 12 includes, amongst other components, a processor 14, a memory 16, and an interface 18 for connecting to external peripherals. The computing system may optionally include a media bay 20 for receiving machine readable media, such as medium 22. A computing system may take the form of a personal computer, including a desktop or laptop computer. A computing system may alternatively be implemented as a handheld computing device, tablet computing device, workstation, console, or virtually any other device capable of processing digital data.

Memory 16 may be used for long term storage of digital data, such as audio-visual data representing audio-visual content. Memory 16 may also be used for storing executable applications, such as audio-visual editing application 24. Such applications may be run by processor 14, and memory 16 may temporarily store digital information to facilitate the running of such applications. Memory 16 may include portions of volatile memory and portions of nonvolatile memory. Memory may be loaded with, or receive, data, applications, and/or other digital information via interface 18, media bay 20, a network interface, or another suitable mechanism. For example, medium 22 may include audio-visual editing application 24, which may be loaded to memory 16. In some embodiments, a computing system may include firmware that is programmed with an audio-visual editing application.

Interface 18 may include a wired and/or wireless data transmission mechanism. Examples of suitable interfaces include, but are not limited to, Universal Serial Bus (USB) and USB 2.0. In some embodiments, interface 18 may be configured to deliver power to a connected peripheral. Although only one interface 18 is illustrated in FIG. 1, it should be understood that computing system 12 may include two or more interfaces. Furthermore, two or more peripherals may be connected to the same interface, such as via a hub or other splitting mechanism.

Audio-visual editing system 10 also includes an audio-visual peripheral 30, which includes, amongst other components, an interface 32, a capture system 34, and a control console 36. Interface 32 is complementarily configured relative to interface 18 of computing system 12, so that digital information may be transferred between the computing system and audio-visual peripheral 30. In some embodiments, audio-visual peripheral 30 may include two or more different types of interfaces to increase compatibility of the audio-visual peripheral. Furthermore, interface 18 may be used with an adapter, which enables otherwise uncompatible interfaces to be used with one another.

Capture system 34 may be used to receive, store, or import, audio visual content, and convert the content into a format compatible with computing system 12. For example, in some embodiments, audio-visual content in the form of one or more analog signals may be received and converted into a digital format compatible with the computing system. The audio-visual content may be received from a variety of sources, including analog video cameras and video recording or playback devices. Conversion from analog signals to digital information may be accomplished using pulse-code modulation or other suitable techniques, which are well known in the field of digital video. The audio-visual content may be captured as “raw footage” and transferred to computing system 12 for further processing, such as to encode and/or compress the footage. In some embodiments, the audio-visual peripheral may be configured to further encode or compress the raw footage before transferring the content to the computing system.

Capture system 34 includes an audio-Visual interface 38 for receiving audio-visual content. In the illustrated embodiment, the capture system includes a video interface 40, a left-channel audio interface 42, and a right-channel audio interface 44, which are adapted to receive and convey analog audio-visual signals. Audio-visual interface 38 may include one or more RCA connectors or other suitable mechanisms for receiving audio-visual content.

Capture system 34 also includes a conversion system 46, which is configured to convert the audio-visual content received via interface 38 into a digital format suitable for transmission to a computing system via interface 32. The conversion system may include an audio coder 47 and/or video coder 48, or a single coder capable of processing audio and video information. A coder may include an integrated circuit, such as a processor or an application-specific integrated circuit (ASIC) for changing the format in which audio-visual content is represented. For example, a coder may be designed to convert an analog video signal into decodable digital information. The capture system may also include a memory 49 configured to temporarily hold data used to convert the audio-visual content into a format suitable for delivery to the computing system. The memory may also serve as a buffer during delivery. Memory 49 may include volatile memory portions, including semiconductor DRAM and EEPROM.

Conversion system 46 may be configured to code from one format to another and vice versa. In other words, the conversion system may decode previously encoded audio content to its original format. For example, in some embodiments, the coders may perform inverse operations. In this manner, audio-visual content may be converted between two or more formats. For example, an analog audio-visual signal may be received by peripheral 30, and converted into digital information. The digital information may then be processed as desired, such as by sending the digital information to and from a computing system for editing. The audio-visual peripheral may then convert the digital information into an analog audio-visual signal for exportation to another device.

Audio-visual peripheral 30 includes a control console 36 that is configured to facilitate user control of computing system 12 and audio-visual editing application 24. The control console may be manually operated by a user to issue commands to the computing system in much the same way as a mouse, trackball, keyboard, or other input device issues commands. Such commands may be sent via interface 32. Therefore, the same interface is adapted to convey digital information, such as digital audio-visual data, and commands for controlling the computing system. The use of a single interface may simplify setting up the peripheral, and fewer expansion ports are needed at the receiving computing system.

Control console 36 may include one or more user operable buttons, keys, dials, trackballs, optical sensing devices, voice recognition mechanisms, etc. for receiving user input. Although described primarily as a control for an audio-visual editing application, it should be understood that the control console may also be used to control other aspects of a computing system, including other applications.

FIGS. 2-4 show an exemplary audio-visual peripheral 50 that includes a control console 52. The various buttons and other controls of control console 52 may be adapted to issue commands to an audio-visual editing application. For example, the audio-visual editing application may be programmed to perform a plurality of functions, which may be initiated by manipulating pull-down menus or other user interface elements within the application. Such functions may instead be directly controlled by the audio-visual peripheral. In other words, the control console may be adapted to provide shortcuts for controlling execution of an audio-visual editing application. In some embodiments, the control console may also be adapted to issue commands that are not otherwise available, thus providing the sole method of controlling certain aspects of an audio-visual editing application.

Control console 52 includes a back button 54, a record button 56, an input button 58, a rewind button 60, a play/pause button 62, a fast-forward button 64, an output button 66, a preview button 68, and a forward button 70. The control console also includes a jog dial 72 and a shutter wheel 74. Audio-visual peripheral 50 and control console 52 are provided as a nonlimiting example of the many configurations that are within the scope of the present teachings. Other embodiments may utilize additional and/or alternative controls.

A shutter wheel, such as shutter wheel 74, may be configured for quickly advancing through several frames of audio-visual content within an audio-visual editing application. Shutter wheel 74 may be ergonomically placed and shaped so as to offer precise user control. The shutter wheel can be constructed from a comfortable, easy to grip material such as rubber. It can also be adapted to selectively increase and/or decrease rotation tension and/or frame advancement rates. Furthermore, the shutter wheel, as well as other controls, may be programmed for customized control.

Jog dial 72 can be configured for more delicate control of frame advancement, such as by directing an audio-visual editing application to advance one frame at a time through audio-visual content. Jog dial 72 can be ergonomically placed and shaped so as to offer precise control by a user. The jog dial can be constructed from a comfortable, easy to grip material such as rubber, and may be adapted to selectively increase and/or decrease rotation tension and/or frame advancement speed.

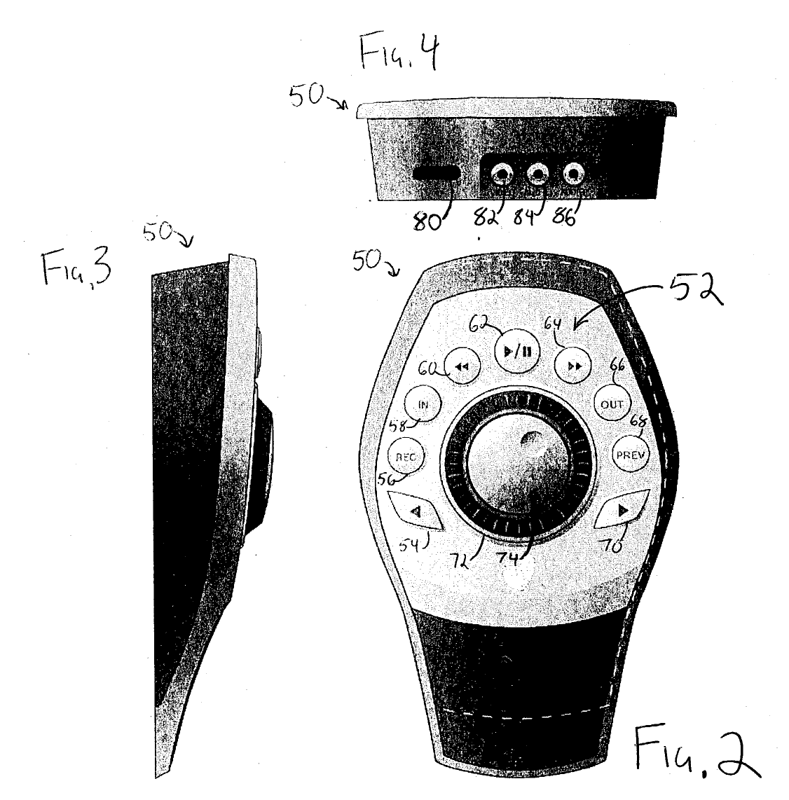

FIG. 4 shows an exemplary arrangement of interfaces on a back side of peripheral 50. In particular, a USB interface 80, a video interface 82, a left audio interface 84, and a right audio interface 86 are shown. It should be understood that the above are provided as examples, and that other arrangements are within the scope of this disclosure. In some embodiments, one or more interface may include a cable or other signal conveyor, which may be coupled with a computing system. As shown, some interfaces may be configured to receive such a cable.

Audio-visual editing application 24 may be used by a computing system to edit audio-visual content. As used herein, the term “editing” means that one or more aspects of the audio-visual content is altered in a desired manner. For example, editing may include adding visual affects; converting color video content to black-and-white, sepia, or another hue; adding tracers to characters and/or objects in the video; zooming, focusing, or unfocusing selected portions of video; and/or adding motion effects such as strobe, slow-motion, fast-motion, and/or reverse motion. Editing may additionally or alternatively include arranging, rearranging, and/or digitally splicing, or otherwise mixing two or more video clips together, with or without a transition, such as a fade, dissolve, or wash. In some embodiments, digital filters may be used to change the appearance of audio-visual content. Furthermore, audio-visual editing application 24 may be configured to utilize plug-ins that add editing functionality. Audio content and video content may be edited separately or collectively. Audio-visual editing application 24 may be used to layer two or more audio tracks over edited or unedited video content. Audio tracks and portions thereof may be arranged, rearranged, and digitally spliced together or deleted.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the disclosure recites “a” or “a first” element or the equivalent thereof, such disclosure should be understood to include incorporation of one or more such elements, neither requiring nor excluding two or more such elements.

Inventions embodied in various combinations and subcombinations of features, functions, elements, and/or properties may be claimed in a related application. Such new claims, whether they are directed to a different invention or directed to the same invention, whether different, broader, narrower or equal in scope to any original claims, are also regarded as included within the subject matter of the inventions of the present disclosure.

What is claimed is:

1. An audio-visual peripheral, comprising:
a capture system configured to convert an analog audio-visual signal into digital audio-visual data;
an interface configured to transfer the digital audio-visual data to a computing system programmed to execute an audio-visual editing application; and
a control console configured to control execution of the audio-visual editing application via the interface.

2. The audio-visual peripheral of claim 1, wherein the capture system includes at least one analog input configured to receive the analog audio-visual signal.

3. The audio-visual peripheral of claim 1, wherein the capture system includes a memory.

4. The audio-visual peripheral of claim 3, wherein the memory includes volatile semiconductor memory portions.

5. The audio-visual peripheral of claim 1, wherein the capture system includes an analog-to-digital converter.

6. The audio-visual peripheral of claim 1, wherein the capture system includes a data compressor.

7. The audio-visual peripheral of claim 1, wherein the interface includes a wired transmission mechanism.

8. The audio-visual peripheral of claim 7, wherein the interface includes a Universal Serial Bus.

9. The audio-visual peripheral of claim 1, wherein the interface includes a wireless transmission mechanism.

10. The audio-visual peripheral of claim 1, wherein the control console includes a control adapted to control frame advancement during execution of the audio-visual editing application.

11. The audio-visual peripheral of claim 1, wherein the control includes a jog dial.

12. The audio-visual peripheral of claim 1, wherein the control includes a shutter wheel.

13. An audio-visual peripheral for a computing system configured to run an audio-visual editing application, the audio-visual peripheral comprising:
an analog audio-visual interface configured to receive an analog audio-visual signal from an audio-visual device;
a conversion system configured to receive the analog audio-visual signal from the analog audio-visual interface and convert the analog audio-visual signal into digital audio-visual data;
an interface configured to transfer the digital audio-visual data to the computing system; and
a control console including a plurality of user operable controls for issuing commands to the computing system, wherein the commands cause the computer to edit the digital audio-visual data via execution of the audio-visual editing application.

14. An audio-visual peripheral, comprising:
means for receiving an audio-visual signal;
means for converting the audio-visual signal into digital data;
means for transferring the digital data to a computing device programmed to execute an audio-visual editing application; and
means for controlling the computing device during execution of the audio-visual editing application.

15. An audio-visual editing kit, comprising:
a computer readable medium including a plurality of instructions that provide for editing audio-visual content when the instructions are executed by a computing system; and
an audio-visual peripheral configured to operationally cooperate with the computing system, the audio-visual peripheral including:
an audio-video capture system configured to convert an analog audio-visual signal into audio-visual data, wherein the analog audio-visual signal and the audio-visual data represent the audio-visual content;
an interface configured to transfer the audio-visual data to the computing system; and
one or more user operable controls configured to cause the computing system to execute the instructions that provide for editing the audio-visual content.
